(19) United States
(12) Patent Application Publication
(10) Pub. No.: US 2025/0036300 A1
(43) Pub. Date: Jan. 30, 2025

(54) CONTROLLER, STORAGE DEVICE, AND METHOD FOR SETTING A TEST MODE OF A STORAGE DEVICE

(71) Applicant: SK hynix Inc., Icheon-si, Gyeonggi-do (KR)

(72) Inventors: Soon Hyun KWON, Icheon-si (KR); Jin Sub KIM, Icheon-si (KR)

(21) Appl. No.: 18/542,538

(22) Filed: Dec. 15, 2023

(30) Foreign Application Priority Data
Jul. 24, 2023 (KR) 10-2023-0095748

(51) Int. Cl. G06F 3/06

(52) U.S. Cl. CPC G06F 3/0653; G06F 3/0604; G06F 3/0679

(57) ABSTRACT

A storage device comprises a nonvolatile memory including a plurality of memory blocks, and a controller configured to control an operation of the nonvolatile memory, generate a mapping table that maps physical addresses and logical addresses for the plurality of memory blocks in a test mode, and set a fake block bitmap indicating whether each of the plurality of memory blocks included in the mapping table is a fake block to which data is not written.

### CROSS-REFERENCE TO RELATED APPLICATION

The present application claims priority under 35 U.S.C. § 119(a) to Korean Patent Application No. 10-2023-0095748 filed in the Korean Intellectual Property Office on Jul. 24, 2023, which is incorporated herein by reference in its entirety.

### BACKGROUND

### 1. Technical Field

Various embodiments of the present disclosure generally relate to a controller, a storage device, and a method for setting a test mode of a storage device.

### 2. Related Art

A storage device may include a memory that includes a plurality of memory cells and stores data. The storage device may include a controller that controls the operation of the memory.

The controller may control, according to a command inputted from the outside, an operation of writing data to the memory or an operation of reading or erasing data written to the memory.

When control by the controller is not normally performed, the performance of the storage device may degrade, or the device may experience failure. Therefore, a test to determine whether the controller performing control operations in a normal manner may be required.

### SUMMARY

Various embodiments of the present disclosure are directed to providing measures capable of quickly and variously testing whether the operation of a controller included in a storage device and whether the storage device is operating normally under control of the controller.

In an embodiment, a storage device may include: a nonvolatile memory including a plurality of memory blocks; and a controller configured to control an operation of the nonvolatile memory, generate a mapping table that maps physical addresses and logical addresses for the plurality of memory blocks in a test mode, and set a fake block bitmap indicating whether each of the plurality of memory blocks included in the mapping table is a fake block to which data is not written.

In an embodiment, a method for setting a test mode of a storage device may include: mapping an arbitrary physical address to a logical address in a test mode; generating a mapping table that maps the physical address and the logical address using a mapping relationship; and setting a fake block bitmap indicating whether a memory block included in the mapping table is a fake block to which data is not written.

In an embodiment, a controller may include: an interface configured to receive a test mode start signal from the outside; and a control circuit configured to operate in a test mode according to the test mode start signal, generate a mapping table between physical addresses and logical addresses according to a plurality of memory blocks in the test mode, and set a fake block bitmap indicating whether the memory block included in the mapping table is a fake block to which data is not written.

According to the embodiments of the present disclosure, it is possible to variously test whether a controller included in a storage device is performing in a normal or routine manner, and it is possible to reduce a time required for preparation of such tests.

### BRIEF DESCRIPTION OF THE DRAWINGS

FIG. 1 is a diagram schematically illustrating a storage device configuration according to an embodiment of the present disclosure.

FIG. 2 is a diagram illustrating an example of a configuration of a storage device operating in a test mode according to an embodiment of the present disclosure.

FIG. 3 is a diagram illustrating a mapping table generated by a storage device in a test mode according to an embodiment of the present disclosure.

FIG. 4 is a diagram illustrating a fake block bitmap generated by a storage device in a test mode according to an embodiment of the present disclosure.

FIG. 5 is a diagram illustrating an operation performed by a storage device in a test mode according to a read command or a write command according to an embodiment of the present disclosure.

FIG. 6 is a diagram illustrating garbage collection performed by a storage device in a test mode according to an embodiment of the present disclosure.

FIG. 7 is a diagram illustrating another mapping table generated by a storage device in a test mode according to an embodiment of the present disclosure.

FIG. 8 is a diagram illustrating another fake block bitmap generated by a storage device in a test mode according to an embodiment of the present disclosure.

FIG. 9 is a diagram illustrating yet another example of an operation performed by a storage device in a test mode according to a read command or a write command according to an embodiment of the present disclosure.

FIGS. 10 and 11 are diagrams illustrating further examples of garbage collection operations performed by a storage device in a test mode according to an embodiment of the present disclosure.

FIG. 12 is a diagram illustrating a method for setting a test mode of a storage device according to an embodiment of the present disclosure.

### DETAILED DESCRIPTION

In the following description of examples or embodiments of the present disclosure, reference will be made to the accompanying drawings in which it is shown by way of illustration specific examples or embodiments that can be implemented, and in which the same reference numerals and signs can be used to designate the same or like components, even when they are shown in different accompanying drawings. Further, in the following description of examples or embodiments of the present disclosure, detailed descriptions of well-known functions and components incorporated herein will be omitted when the description may make the subject matter in some embodiments of the present disclosure rather unclear. Terms such as “including”, “having”, “containing”, “constituting” “make up of”, and “formed of” used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the present disclosure. Each of these terms is not used to define essence, order, sequence, or number of elements etc., but is used merely to distinguish the corresponding element from other elements.

When that the description includes a first element that “is connected or coupled to”, “contacts or overlaps” etc. a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, etc. each other via a fourth element. Here, the second element may be included in at least one of two or more elements that “are connected or coupled to”, “contact or overlap”, etc. each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is also used.

In addition, when any dimensions, relative sizes etc. are described, it should be considered that numerical values for an elements or features, or corresponding information (e.g., level, range, etc.) include a tolerance or error range that may be caused by various factors (e.g., process factors, internal or external impact, noise, etc.), even when a relevant description is not specified. Further, the term “may” fully encompasses all the meanings of the term “can”.

Hereinafter, various embodiments of the present disclosure will be described in detail with reference to accompanying drawings.

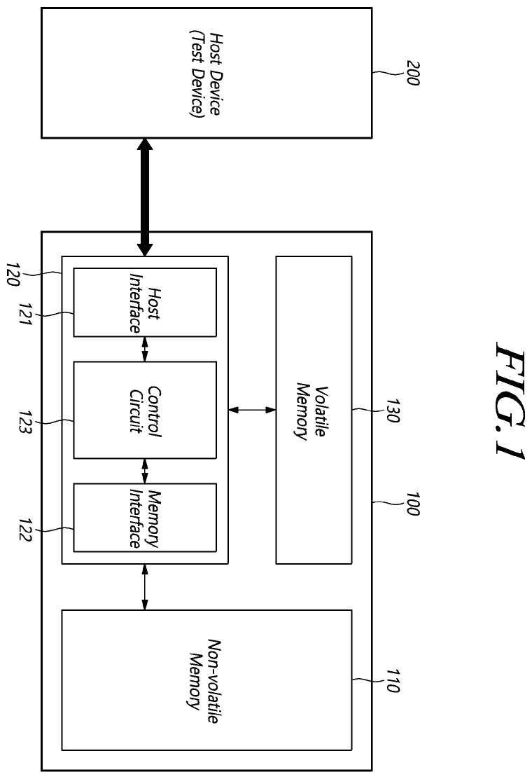

FIG. 1 is a diagram schematically illustrating a storage device configuration according to an embodiment of the present disclosure.

Referring to FIG. 1, a storage device 100 may include a nonvolatile memory 110 that stores data. The storage device 100 may include a controller 120 that controls the operation of the nonvolatile memory 110. the storage device 100 may further include a volatile memory 130, which stores data required for the operation of the controller 120.

For example, the nonvolatile memory 110 may be implemented into various types of memory such as a NAND flash memory, a 3D NAND flash memory, a NOR flash memory, a resistive random access memory, a phase-change random access memory, a magnetoresistive random access memory, a ferroelectric random access memory, and a spin transfer torque random access memory. The nonvolatile memory 110 may be implemented in a three-dimensional array structure. Embodiments of the present disclosure may be applied to not only a flash memory in which a charge storage layer is configured by a floating gate but also to a charge trap flash memory in which a charge storage layer is configured by an insulating film.

The nonvolatile memory 110 may include a plurality of memory blocks. The nonvolatile memory 110 may include a memory cell array including a plurality of memory cells that store data, and the memory cell array may exist in a memory block.

The nonvolatile memory 110 may operate in response to control of the controller 120. Operations of the nonvolatile memory 110 may include, for example, a program operation (also referred to as a “write operation”), an erase operation, and a read operation.

The controller 120 may control program, erase, read, and background operations on the nonvolatile memory 110. Background operations may include, for example, at least one among garbage collection, wear leveling, read reclaim, and bad block management.

The controller 120 may control an operation of testing the performance of the nonvolatile memory 110 or the storage device 100.

The controller 120 may control the operation of the nonvolatile memory 110 according to a request of a device located outside the storage device 100. The controller 120 may also control the operation of the nonvolatile memory 110 regardless of a request from the outside.

For example, the controller 120 may control the operation of the nonvolatile memory 110 according to a request of a host device 200. The storage device 100 and the host device 200 may be collectively referred to as a computing system.

For example, the host device 200 may be a computer, an ultra mobile PC (UMPC), a workstation, a personal digital assistant (PDA), a tablet, a mobile phone, a smartphone, an e-book, a portable multimedia player (PMP), a portable game player, a navigation device, a black box, a digital camera, a digital multimedia broadcasting (DMB) player, a smart television, a digital audio recorder, a digital audio player, a digital picture recorder, a digital picture player, a digital video recorder, a digital video player, a storage configuring a data center, one of various electronic devices configuring a home network, one of various electronic devices configuring a telematics network, an RFID (radio frequency identification) device, a movable device, operated under human control or in autonomous driving, (e.g., a vehicle, a robot, or a drone), and others. Alternatively, the host device 200 may be a virtual/augmented reality device that provides a 2D or 3D virtual reality image or augmented reality image. The host device 200 may be any one of various electronic devices which require the storage device 100 capable of storing data.

The host device 200 may include at least one operating system. The operating system may manage and control overall functions and operations of the host device 200, and may control interoperations between the host device 200 and the storage device 100. The operating system may be classified as a general operating system or a mobile operating system depending on the mobility of the host device 200.

The controller 120 and the host device 200 may be devices that are separated from each other. The controller 120 and the host device 200 may be implemented by being integrated into one device. Hereunder, for convenience in explanation, the controller 120 and the host device 200 will be described as separate devices.

The controller 120 may include a host interface 121, which provides an interface for communication with the host device 200, and a memory interface 122, which provides an interface for communication with the nonvolatile memory 110.

The controller 120 may include a control circuit 123, which controls overall operations of the controller 120. For example, the control circuit 123 may include at least one of a processor, a working memory, and so on, and may optionally further include an error detection and correction circuit.

The control circuit 123 may communicate with the host device 200 through the host interface 121, and may communicate with the nonvolatile memory 110 through the memory interface 122.

The control circuit 123 may perform the function of a flash translation layer (FTL). The control circuit 123 may translate a logical block address provided by the host device 200 into a physical block address through the flash translation layer. Specifically, the flash translation layer may receive a logical block address from the host device 200 and translate the received logical block address into a physical block address using a mapping table.

The control circuit 123 may execute firmware to control the operation of the controller 120. Upon booting, the control circuit 123 may execute or drive the firmware included in the working memory. An operation of the storage device 100 described in embodiments of the present disclosure may be implemented in such a way that the control circuit 123 executes firmware that defines the corresponding operation.

The firmware, as a program to be executed in the storage device 100 to drive the storage device 100, may include various functional layers. For example, the firmware may include binary data that define codes for executing the respective functional layers.

For example, the firmware may include at least one among a flash translation layer (FTL), which performs a translating function between a logical address requested to the storage device 100 from the host device 200 and a physical address of the nonvolatile memory 110; a host interface layer (HIL), which analyzes a command requested to the storage device 100 from the host device 200 and transfers the command to the flash translation layer (FTL); and a flash interface layer (FIL) that transfers a command, instructed from the flash translation layer (FTL), to the nonvolatile memory 110.

For example, the firmware may be loaded into the working memory from the nonvolatile memory 110 or from a separate nonvolatile memory (e.g., a ROM or a NOR Flash) located outside the nonvolatile memory 110. The control circuit 123 may first load the entirety or a part of the firmware into the working memory when executing a booting operation after power-on.

The control circuit 123 may perform a logic operation that is defined in the firmware loaded into the working memory, to control overall operations of the controller 120. The control circuit 123 may control the controller 120 to generate a command or a signal according to a result of performing the logic operation defined in the firmware. If a part of the firmware that defines a logic operation to be performed is not loaded into the working memory, the control circuit 123 may generate an event (e.g., an interrupt) for loading the corresponding part of the firmware into the working memory.

The working memory may store the firmware, program codes, commands, or data that is necessary to drive the controller 120. The working memory may be, for example, a volatile memory and may include at least one among an SRAM (static RAM), a DRAM (dynamic RAM) and an SDRAM (synchronous DRAM).

The working memory may be located inside or outside the controller 120. Working memories may be located both inside and outside the controller 120.

The storage device 100 may further include a volatile memory 130 that is located outside the controller 120. The volatile memory 130 may be the above-described working memory or a memory, which is disposed separately from the above-described working memory. The volatile memory 130 may be a DRAM, but is not limited DRAMs.

Under control of the host device 200, the storage device 100 may perform an operation of testing its own operational performance or the performance of a component included in the storage device 100. In addition, performance tests may be controlled by a test device separate from the host device 200. In such cases, the storage device 100 and the test device may be collectively referred to as a testing system.

Hereinafter, an operation of testing the performance of the storage device 100 will be described as being performed under control of the host device 200 as an example, but as described above, the operation of testing the performance of the storage device 100 may be performed by a separate test device. That is, embodiments described for testing the storage device 100 under the control of the host device 20 may also be applied to the testing of the storage device 100 under the control of a separate test device.

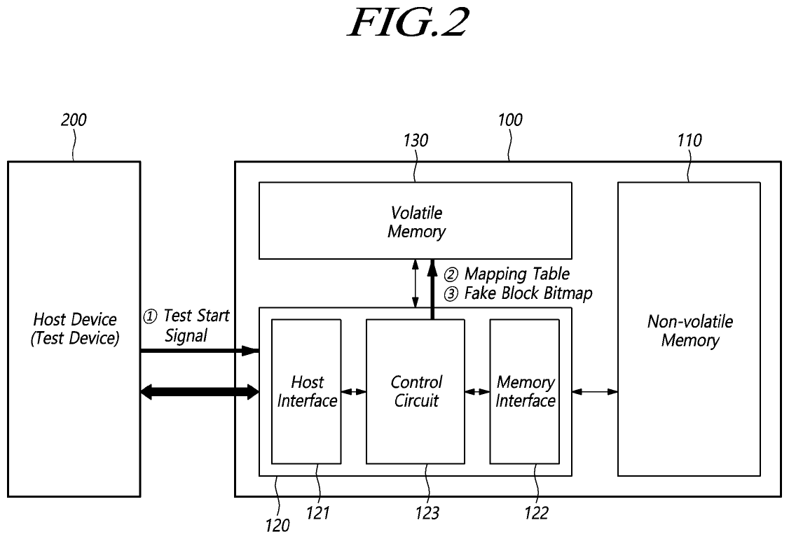

FIG. 2 is a diagram illustrating an example of a configuration of a storage device operating in a test mode according to an embodiment of the present disclosure.

Referring to FIG. 2, a storage device 100 may operate in a test mode according to a control signal received from the host device 200 or the test device. For example, the storage device 100 may receive a test mode start signal from the host device 200 (\textcircled{1} Test Start Signal).

In the test mode, the storage device 100 may operate according to a command received from the host device 200. In the test mode, the host device 200 may check whether the storage device 100 operates normally or may check on the operational performance of the storage device 100.

When receiving the test mode start signal, the storage device 100 may perform a basic setting operation, which sets a state in which a test is to be performed. For example, when receiving the test mode start signal, the storage device 100 may execute firmware for a test mode preparation operation.

For example, the firmware for the test mode preparation operation may be stored in the storage device 100 in a disabled state, but the firmware for the test mode preparation operation may be enabled according to the test mode start signal received from the host device 200. Alternatively, the firmware for the test mode preparation operation may be enabled according to an enable signal that is received from the host device 200 separately from the test mode start signal.

The controller 120 of the storage device 100 may generate a mapping table when the firmware for the test mode preparation operation is executed (\textcircled{2} Mapping Table). The controller 120 may store the generated mapping table, for example, in the volatile memory 130.

For example, the mapping table may be a table that represents the mapping relationship between a logical address received from the host device 200 and a physical address of the nonvolatile memory 110.

When the storage device 100 receives the test mode start signal, the nonvolatile memory 110 included in the storage device 100 may be in a state in which data is not stored, or it may be in a state in which data is stored in a part or in the entirety of the nonvolatile memory 110.

When data is not stored, either in a part of or in the entirety of the nonvolatile memory 110, a process of writing data to at least a part of a memory block included in the nonvolatile memory 110 may be required in order to test the operational performance of the storage device 100.

According to embodiments of the present disclosure however, in the test mode, the mapping table may be generated in a manner that reduces the amount of time to write data required for the test of a memory block of the nonvolatile memory 110.

The mapping table may represent the mapping relationship between a logical address and a physical address. Since the mapping relationship between the logical address and the physical address exists, the host device 200 and the controller 120 can use the physical address mapped to the logical address to perform operations for the test as if data is written to the physical address.

Using the mapping table according to embodiments of the disclosure, the host device 200 and the controller 120 operate as if data is written to the physical address mapped to the logical address, even if no actual data is written to the physical address. As a result, it is not necessary to perform a process of writing actual data to a memory block included in the nonvolatile memory 110. Therefore, it is possible to reduce a time for writing data necessary for a test to the nonvolatile memory 110 or eliminate this step entirely.

Using the mapping table according to embodiments of the disclosure, the controller 120 may generate a bitmap for a memory block in which actual data is not written.

In the present specification, a memory block that does not have actual data written to it but is recognized as having data written to it according to the mapping table may be referred to as a fake block.

A fake block may mean a memory block to which actual data used for a test is not written, but is nevertheless recognized or considered as having data written to it according to a mapping table. A memory block other than a fake block may be referred to as a normal block.

The controller 120 may set, on the basis of the mapping table, a fake block bitmap indicating whether a memory block included in the mapping table is a fake block, to which test data is not written (\textcircled{3} Fake Block Bitmap).

The controller 120 may store the fake block bitmap in the volatile memory 130. The controller 120 may also store the fake block bitmap in the working memory in the controller 120.

The fake block bitmap may include a value indicating whether a memory block included in the nonvolatile memory 110 is a fake block.

In addition, the fake block bitmap may have a format including a value indicating whether a super block, which is configured by at least two memory blocks, is a fake block.

A super block may be a unit of memory blocks that is logically managed.

The fake block bitmap may include a value indicating whether each of a plurality of super blocks, which is configured by memory blocks, included in the nonvolatile memory 110 is a fake block.

As described above, the controller 120 may reduce a time required to write data for the test, through the generation of the mapping table.

In addition, since the fake block to which actual data is not written is managed through the fake block bitmap, the controller 120 may perform a test operation while checking whether a memory block or a super block is written with actual data.

The controller 120 may generate the mapping table between a logical address and a physical address in various ways. For example, the controller 120 may generate the mapping table by first generating a mapping table between a logical address and a virtual physical address. The controller 120 may set the aforementioned fake block bitmap after generating the mapping table.

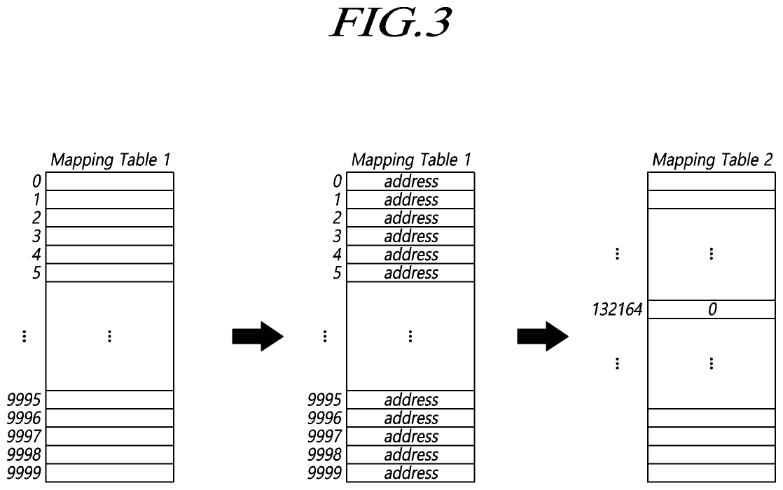

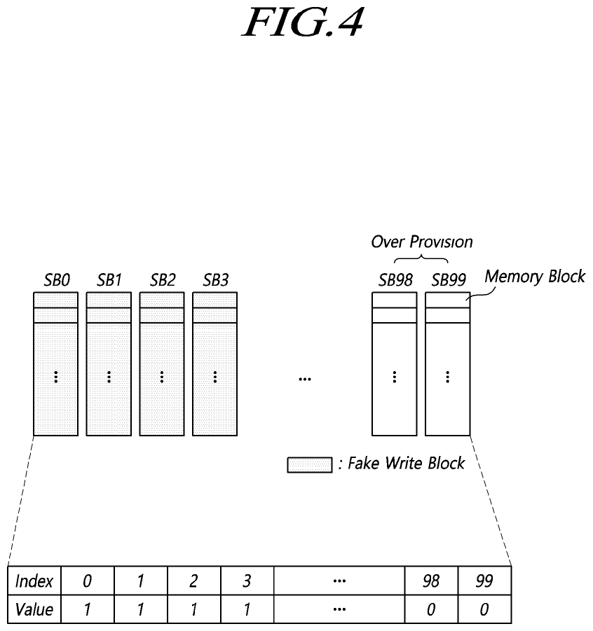

FIG. 3 is a diagram illustrating a mapping table generated by a storage device in a test mode according to an embodiment of the present disclosure. FIG. 4 is a diagram illustrating a fake block bitmap set by a storage device in a test mode according to an embodiment of the present disclosure.

Referring to FIG. 3, a controller 120 of a storage device 100 may update or generate a first mapping table in a test mode. The first mapping table may be, for example, an L2V mapping table, which represents the mapping relationship between a logical address and a virtual physical address.

In the test mode, all or some of the memory blocks included in the nonvolatile memory 110 may be in a state in which they are not written with data.

Since the memory blocks of the nonvolatile memory 110 are in a state in which data is not written, the first mapping table may be in a state in which the virtual physical address is not stored therein. In FIG. 3, the table on the left includes, as an example, 0 to 9999 as logical addresses and shows the first mapping table in a state in which virtual physical addresses, corresponding to the logical addresses 0 to 9999, are not stored in the test mode.

When receiving a test mode start signal from the outside, the controller 120 may update the first mapping table. The controller 120 may also update the first mapping table without receiving a write command from the outside.

Thus, as shown in the table in the center of FIG. 3, the controller 120 may update the first mapping table by mapping an arbitrary virtual physical address to a logical address. The arbitrary virtual physical address may be mapped and stored for each of the logical addresses 0 to 9999. The arbitrary virtual physical address is an address designating a location where data is to be written in the nonvolatile memory 110, and may also designate, for example, information such as a super block (or a memory block), a word line, and an offset.

When the first mapping table is updated, the controller 120 may generate a second mapping table on the basis of the first mapping table. The second mapping table may be, for example, a mapping table that represents the P2L mapping relationship between a physical address and a logical address.

For example, as shown in the last table on the right in FIG. 3, the logical address 0 may be mapped to a physical address 132164, which means that data corresponding to the logical address 0 is stored at a location indicated by the physical address 132164. As described above, the physical address 132164 may indicate information such as a super block (or a memory block), a word line, and an offset included in the nonvolatile memory 110.

The controller 120 may update the first mapping table so that arbitrary virtual physical addresses are mapped to all logical addresses in the first mapping table and then may generate the second mapping table on the basis of the first mapping table. The first mapping table may map the virtual physical address to the logical address. The second mapping table may map the logical address to the virtual physical address. The second mapping table may represent a reverse mapping table of the first mapping table.

Since the controller 120 may generate the second mapping table without receiving a write command, time to write actual data to the nonvolatile memory 110 may not be required. In the test mode, the host device 200 and the controller 120 may be set in a state in which data is assumed to be written to the nonvolatile memory 110, without requiring time to write actual data.

The controller 120 may set, according to the second mapping table, a fake block bitmap for managing a memory block, which does not contain actual data but is recognized as having written data.

In an example, FIG. 4 illustrates memory blocks, included in a nonvolatile memory 110, which are managed by being divided into 100 super blocks. The nonvolatile memory 110 may include, for example, 100 super blocks SB0, . . . , SB99.

The super blocks SB0 to SB97 may be super blocks in which data may be actually stored. The super blocks SB98 and SB99 may be super blocks which are set as over-provision regions, which are included in regions not provided to a user.

As the controller 120 generates a second mapping table, at least some super blocks among the super blocks included in the nonvolatile memory 110 may be recognized as super blocks to which data is written. A super block recognized as being written with data without actual data being written may be referred to as a fake block (or a fake write block).

When the controller 120 maps physical addresses to all logical addresses in the second mapping table, the remaining super blocks except a super block set as an over-provision region from among the plurality of super blocks may be set as fake blocks.

The controller 120 may set a fake block bitmap, which indicates the super blocks set as fake blocks and the super blocks other than the fake blocks.

In the example shown in FIG. 4, the controller 120 may set a fake block bitmap that indicates whether each super block is a fake block. When a super block is a fake block, the controller 120 may set a value corresponding to the index of the super block to “1.” When a super block is not a fake block, the controller 120 may set a value corresponding to the index of the super block to “0.”

For example, the controller 120 may set values corresponding to the super blocks SB0 to SB97 to “1” and values corresponding to the super blocks SB98 and SB99 to “0” in the fake block bitmap.

The fake block bitmap may be stored, for example, in the volatile memory 130. Alternatively, the fake block bitmap may be stored in the working memory located inside the controller 120.

Since the second mapping table is generated and the fake block bitmap is set by the controller 120, a state for performing the test can be prepared while managing fake blocks and reducing the time needed for test preparation operations.

In a state in which the preparation for the test is completed by the controller 120, the test may be performed according to an input from the host device 200 or the test device.

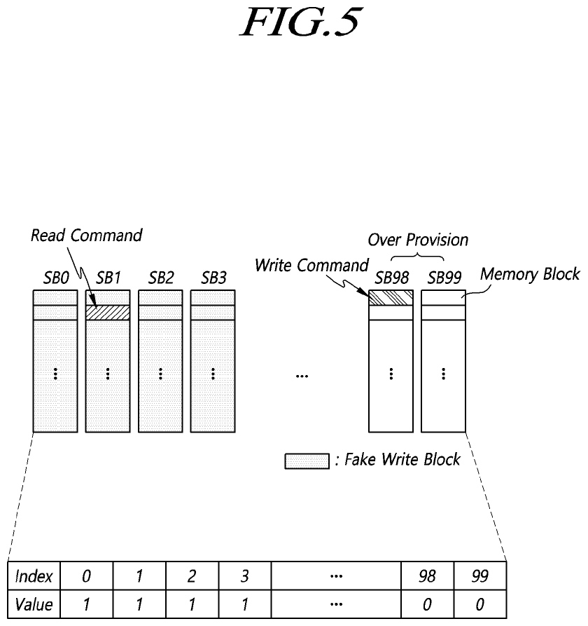

FIG. 5 is a diagram illustrating an operation performed by a storage device in a test mode according to a read command or a write command according to an embodiment of the present disclosure.

Referring to FIG. 5, a controller 120 of a storage device 100 may receive a command such as a read command or a write command from a host device 200. The controller 120 may perform an operation corresponding to the command received from the host device 200.

For example, the controller 120 may receive a read command from the host device 200. The read command received by the controller 120 may be a read command for a memory block to which data is written, or a read command for a fake block to which data is not written.

If the controller 120 receives the read command for the fake block, and there is no data written to the fake block, then the controller 120 may output a value obtained on the basis of information associated with the fake block as a value corresponding to the read command.

For example, the controller 120 may generate a hash value by using a logical address corresponding to the physical address of the fake block as a key value. The controller 120 may transmit the generated hash value to the host device 200 as a value corresponding to the read command.

Since the read command by the host device 200 and the hash value by the controller 120 use the logical address in common according to the read command, the host device 200 may check whether the value returned from the controller 120 is a value corresponding to the read command.

By checking whether the returned value is correct, the host device 200 can check whether a read operation on a memory block corresponding to the logical address according to the read command has been performed in a normal manner.

Accordingly, in a state in which actual data is not written to the memory block of the nonvolatile memory 110, it is possible to check whether the read operation according to the read command of the host device 200 is performing correctly.

Meanwhile, if the controller 120 receives a write command from the host device 200, then the controller 120 may perform a write operation according to the write command.

If an empty block exists among the memory blocks or the super blocks included in the nonvolatile memory 110, then the controller 120 may write data according to the write command to the empty block. The empty block may mean a block in which a data is not written.

If the memory block indicated by the write command is a fake block, then the controller 120 may change the physical address corresponding to the logical address according to the write command to the physical address of the empty block. The controller 120 may write the data according to the write command to the empty block.

In this way, an operation according to a read command or a write command may be performed in a state in which at least some of the super blocks included in the nonvolatile memory 110 are set as fake blocks, and the test for the storage device 100 may be performed more efficiently.

When performing a write operation according to a write command, if the number of free blocks is insufficient, then a garbage collection operation may be performed. That is, if the number of free blocks is less than a preset value, then the controller 120 may perform a garbage collection operation. The free block may mean a block in which a data can be written. The free block may be an empty block, or a block in which an invalid data is written.

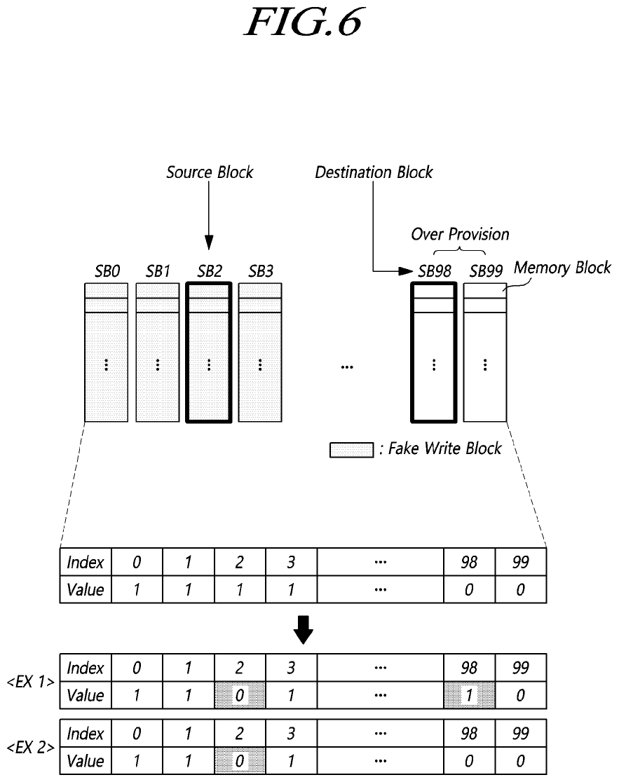

FIG. 6 is a diagram illustrating garbage collection performed by a storage device in a test mode according to an embodiment of the present disclosure.

Referring to FIG. 6, after generation of a second mapping table in a test mode, 98 super blocks among the 100 super blocks are set as fake blocks and the remaining two super blocks are set as over-provision regions as an example.

The controller 120 may exclude the fake blocks from the free blocks.

The controller 120 may perform a garbage collection operation after determining that a free block does not exist.

The controller 120 may select one of the fake blocks as a source block for the garbage collection operation. For example, in FIG. 6, the controller 120 may select the super block SB2 as a source block. The controller 120 may select the super block SB98 as a destination block.

If the garbage collection operation is performed by selecting a fake block as the source block, then the controller 120 may perform the garbage collection operation without writing actual data to the destination block.

Since no data is written to the source block, the controller 120 does not perform an operation of writing data to the destination block. In this case, as in <EX 1> in FIG. 6, the controller 120 may change the value of the destination block in the fake block bitmap to “1” indicating a fake block.

When the garbage collection operation is completed, the controller 120 may change the value of the source block (e.g., super block SB2) in the fake block bitmap to “0” indicating not a fake block.

The controller 120 may change the value of the source block in the fake block bitmap when the garbage collection operation is completed. In this case, the controller 120 may change the value of the source block in the fake block bitmap after the garbage collection operation is completed and before writing new data to the source block.

Accordingly, as data is written to the super block that is changed from a fake block to a normal block, a test may be performed according to a state in which data is written to each super block.

According to the setting of a fake block, the garbage collection operation may be performed at an earlier time point in the test mode. In addition, by setting the destination block as a fake block, the garbage collection operation may be performed based on a fake block not written with data.

Alternatively, specific data may be written to the destination block according to the garbage collection operation.

For example, as a garbage collection operation is performed between a source block that is a fake block and a destination block, the controller 120 may write a value, which would be output in a read operation on the fake block, to the destination block instead. As described above, in a read operation on a fake block, the controller 120 may transmit a value, generated on the basis of a logical address associated with the fake block, to the host device 200. The controller 120 may write a value to be returned in the read operation on the fake block to the destination block.

Referring to FIG. 6, as in <EX 2>, since the destination block is a memory block to which actual data is written, the value of the destination block in the fake block bitmap may be maintained as “0.”

When the garbage collection operation is completed, the value of the source block in the fake block bitmap may be changed to “0.” Alternatively, after the garbage collection operation is completed and before new data is written to the source block, the value of the source block in the fake block bitmap may be changed to “0.”

After the garbage collection operation, a test may be performed according to a read command or a write command as the controller 120 controls a read or write operation on a super block.

As such, according to embodiments of the present disclosure, the operational performance of the storage device 100 or the controller 120 can be easily tested while reducing the needed time for test preparation through generation of a mapping table and fake block management using a fake block bitmap in the test mode.

In addition, according to embodiments of the present disclosure, the test for the storage device 100 or the controller 120 may be performed in various ways with the reduced time for test preparation, by setting only some of super blocks included in the nonvolatile memory 110 as fake blocks.

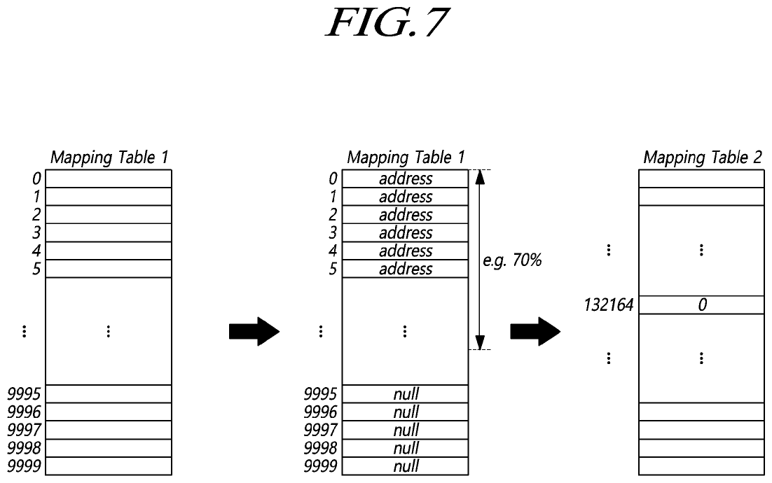

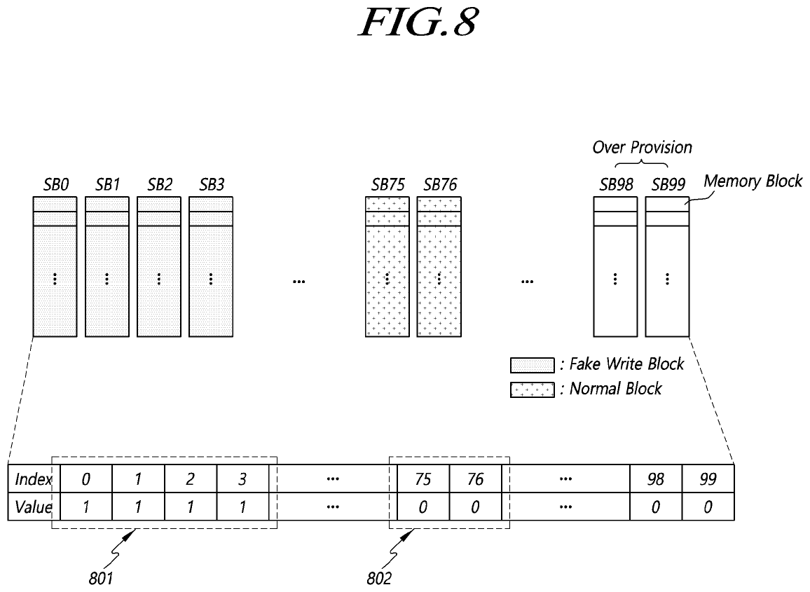

FIG. 7 is a diagram illustrating another mapping table generated by a storage device in a test mode according to embodiment of the present disclosure. FIG. 8 is a diagram illustrating another fake block bitmap generated by a storage device in a test mode according to an embodiment of the present disclosure.

Referring to FIG. 7, a controller 120 of the storage device 100 may update a first mapping table in a test mode. The controller 120 may update the first mapping table without receiving a write command from the outside.

The controller 120 may map virtual physical addresses to some of the logical addresses in the first mapping table.

For example, as shown in the table in the center of FIG. 7, the controller 120 may map virtual physical addresses to logical addresses corresponding to 70% of all logical addresses. The controller 120 may not map virtual physical addresses to the remaining logical addresses.

The controller 120 may generate a second mapping table on the basis of the first mapping table in which virtual physical addresses are mapped to only some logical addresses. The second mapping table in which logical addresses are mapped to some of the memory blocks or the super blocks included in the nonvolatile memory 110 may be generated.

The controller 120 may set a fake block bitmap on the basis of the generated second mapping table.

Referring to FIG. 8, when the memory blocks included in the nonvolatile memory 110 are divided into super blocks SB0, . . . , SB99, some super blocks may be fake blocks that are included in the second mapping table, and such fake blocks are not written with data according to the second mapping table. Some other super blocks may be normal blocks which are not written with data and not included in the second mapping table. Some super blocks may be set as over-provision regions.

The controller 120 may set the value of each super block in the fake block bitmap according to the super block and whether data is written to the second mapping table.

The controller 120 may set the value of super blocks that are included in the second mapping table and are not written with data, such as the super blocks SB0, SB1, and others, to “1” in the fake block bitmap. The controller 120 may set the value of super blocks that are not included in the second mapping table, such as the super blocks SB75 and SB76, to “0” in the fake block bitmap. The controller 120 may set the value of the super blocks SB98 and SB99 that are set as over-provision regions to “0” in the fake block bitmap.

Since the controller 120 sets some super blocks as fake blocks, without writing data to the fake blocks, it is possible to set a state capable of performing the test, while reducing the time required to write data. In addition, since the controller 120 sets some super blocks as fake blocks and sets the remaining super blocks as normal blocks, it is possible to variously set a state in which the test is performed. For example, if all of the super blocks are set as the fake blocks, a garbage collection operation may be performed very soon in a state that a data is not written in all of the super blocks. If some of the super blocks are set as the fake blocks, a time that a data is written in the normal blocks may be necessary. The storage device 100 may operate normally in the time. The garbage collection operation may be delayed. And the garbage collection may be performed in a state that a data is written in some of the super blocks. The garbage collection can be performed in a state that a data is actually not written in the super blocks, in a state that a data is actually written in some of the super blocks, or in a state that a data is actually written in almost of the super blocks.

Data may be written to the normal block in response to a write command, and also, a time point and a way for performing a garbage collection operation may be variously adjusted. Accordingly, the test for the operational performance of the storage device 100 may be performed with different.

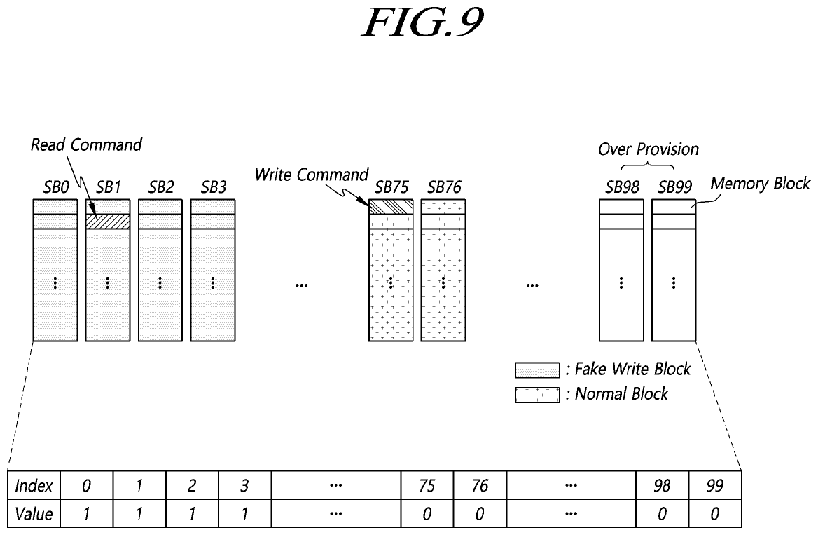

FIG. 9 is a diagram illustrating yet another example an operation performed by a test device in a test mode according to a read command or a write command according to embodiment of the present disclosure.

Referring to FIG. 9, in a test mode in which only some super blocks are set as fake blocks, a controller 120 may receive a read command. The controller 120 may receive the read command for a memory block set as a fake block.

The controller 120 may transmit, to the host device 200, a hash value having a logical address associated with each fake block as a key value in response to the read command for the corresponding fake block.

In a test mode, the controller 120 may receive a write command. If the controller 120 receives the write command for a fake block, then according to the write command the controller 120 may change the physical address corresponding to the logical address to a new physical address, and may write data according to the write command to the memory block indicated by the new physical address.

For example, the controller 120 may write the data according to the write command to the memory block included in the super block set as a normal block.

In a state in which some super blocks are fake blocks assumed to be being written with data and the remaining super blocks are recognized as free or normal blocks, various tests according to commands of the host device 200 may be performed. Even in this case, since a time to write data is not required due to setting of fake blocks, the test for the operational performance of the storage device 100 may be performed with a reduced time for test preparation.

Where only some super blocks are set as fake blocks as described above, as data is written to normal blocks, the number of free blocks may decrease. If the number of free blocks becomes less than a preset value, then the controller 120 may perform a garbage collection operation.

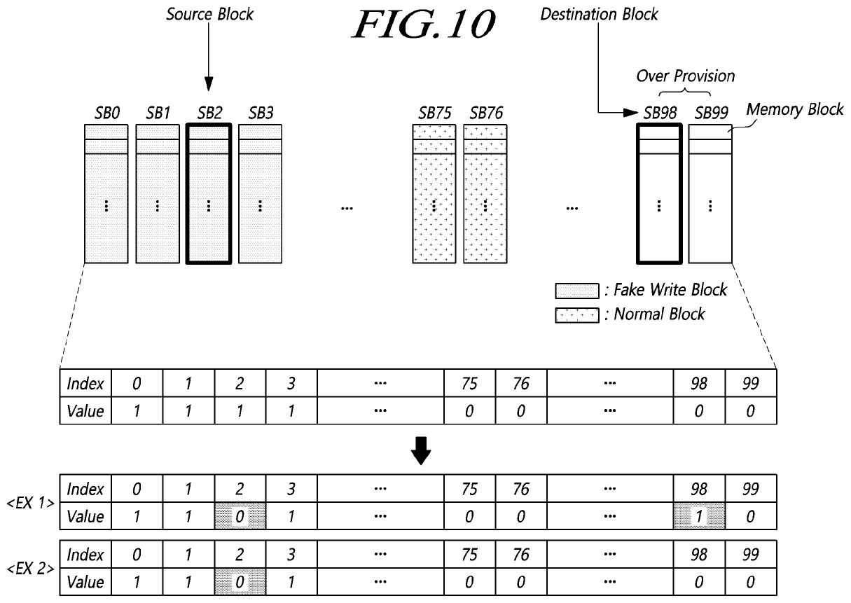

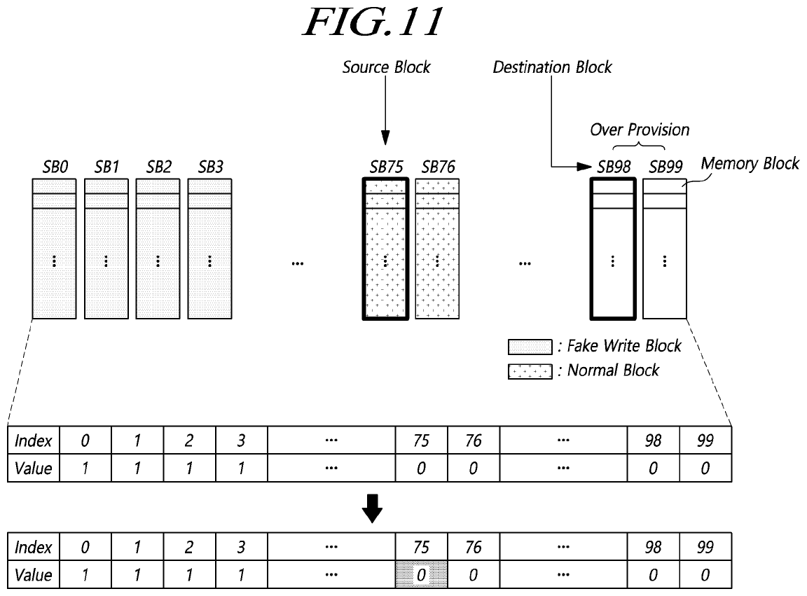

FIGS. 10 and 11 are diagrams illustrating further examples of garbage collection operations performed by a storage device in a test mode according to an embodiment of the present disclosure.

Referring to FIGS. 10 and 11, a controller 120 may perform a garbage collection operation if the number of free blocks among the super blocks included in the nonvolatile memory 110 is less than a preset value.

The controller 120 may select a source block among super blocks, which were set as fake blocks, and super blocks that were set as normal blocks.

For example, as in an example shown in FIG. 10, the controller 120 may select a source block among super blocks set as fake blocks.

The controller 120 may select a source block on the basis of the validity of data written to each super block. A fake block may be recognized as a super block with data written at the earliest time point since the fake block is set before an actual data is written in a normal block, the fake block may be selected as a source block.

For example, the controller 120 may select the super block SB2 as a source block and select the super block SB98 as a destination block.

The controller 120 may perform an operation of moving data of the source block to the destination block.

Referring to FIG. 10, in <EX 1> the source block is a fake block and data is not written to the source block, so the controller 120 may perform a garbage collection operation without actually writing data to the destination block. The controller 120 may change the value of the super block SB98, which is the destination block, to “1” in the fake block bitmap and may change the value of the super block SB2, which is the source block, to “0” in the fake block bitmap.

Alternatively, in <EX 2>, the controller 120 may write a hash value to be returned in a read operation on the source block, which is a fake block, to the destination block. Accordingly, the hash value may be written to the super block SB98, which is the destination block. The value of the super block SB98 in the fake block bitmap, which is the destination block, may be maintained as “0.” The value of the super block SB2 in the fake block bitmap, which is the source block, may be changed to “0.”

In another example, as in an example shown in FIG. 11, the controller 120 may select a super block, which is set as a normal block, as a source block.

The controller 120 may select a source block on the basis of the validity of data written to a super block, from among super blocks. The controller 120 may select a source block among super blocks whose values in the fake block bitmap are “0.”

For example, the controller 120 may select the super block SB75 as a source block and select the super block SB98 as a destination block.

Since the super block SB75, which is the source block, is a normal block to which actual data is written, the controller 120 may perform an operation of moving data of the source block to the destination block. Accordingly, the data may be written to the super block SB98, which is the destination block. The value of the super block SB98 in the fake block bitmap, which is the destination block, may be maintained as “0.” The value of the super block SB75 in the fake block bitmap, which is the source block as a normal block, may also be maintained as “0.”

In a state in which the super blocks included in the nonvolatile memory 110 are set as fake blocks and normal blocks, a source block for a garbage collection operation is variously selected since the source block may be selected according to setting certain super block as the fake block, and the test on the operational performance of the storage device 100 or the controller 120 may be performed.

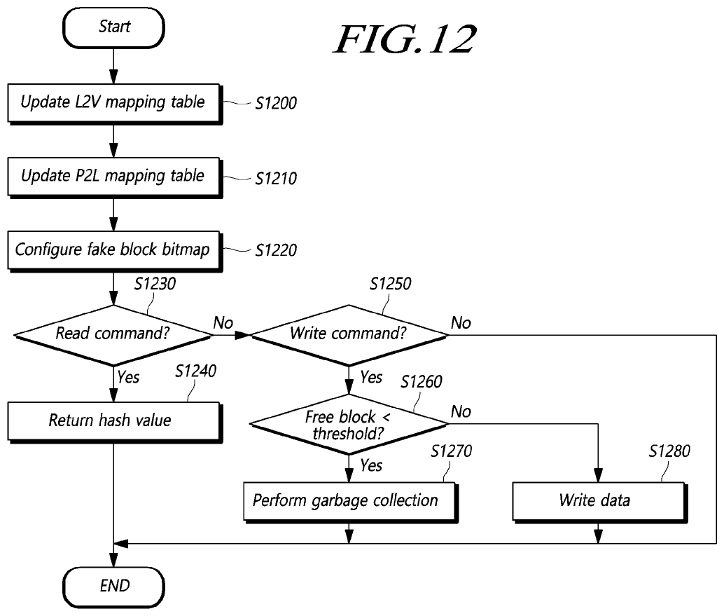

FIG. 12 is a diagram illustrating a method for setting a test mode in a storage device 100 according to an embodiment of the present disclosure.

Referring to FIG. 12, a storage device 100 may update or generate an L2V mapping table in a test mode (S1200). The storage device 100 may update or generate a P2L mapping table using the updated L2V mapping table (S1210).

By updating the L2V mapping table and the P2L mapping table, the storage device 100 may set a state in which the storage device 100 performs a test assuming that data has been written to the nonvolatile memory 110 included in the storage device 100, but actual data has not been written to the nonvolatile memory 110.

The storage device 100 may set a fake block bitmap on the basis of the updated P2L mapping table (S1220). By using the fake block bitmap, the storage device 100 may distinguish a super block to which actual data is written and a super block to which actual data is not written but is nevertheless is considered as being written with data for testing purposes.

If the storage device 100 receives a read command for a memory block set as a fake block (S1230), it may return a hash value generated on the basis of a logical address written in the mapping table (S1240).

Through checking the returned hash value, the host device 200, which has transmitted the read command, may check whether an operation of the storage device 100 corresponding to the read command is normally performed.

If the storage device 100 receives a write command (S1250), then it may check whether the number of free blocks is less than a preset value (S1260). If the number of free blocks is less than the preset value, then the storage device 100 may perform a garbage collection operation (S1270). If the number of free blocks is not less than the preset value, the storage device 100 may perform an operation of writing data to a super block (S1280).

According to embodiments of the present disclosure, through generation of a mapping table in a test mode, data is recognized as being written to a super block of the nonvolatile memory 110. Therefore, it is possible to reduce the time required for writing data to the nonvolatile memory 110 and easily set a preparation state for the test.

In addition, according to the embodiment of the present disclosure, by managing fake blocks and normal blocks through a fake block bitmap set on the basis of the mapping table, it is possible to reduce the time for test preparation and test the operational performance of the storage device 100 through various types of tests.

Although various embodiments of the present disclosure have been described with particular specifics and varying details for illustrative purposes, those skilled in the art will appreciate that various modifications, additions, and substitutions may be made based on what is disclosed or illustrated in the present disclosure without departing from the spirit and scope of the present disclosure as defined in the following claims.

What is claimed is:

1. A storage device comprising:
a nonvolatile memory including a plurality of memory blocks; and
a controller configured to control an operation of the nonvolatile memory, generate a mapping table that maps physical addresses and logical addresses for the plurality of memory blocks in a test mode, and set a fake block bitmap indicating whether each of the plurality of memory blocks included in the mapping table is a fake block to which data is not written.

2. The storage device according to claim 1, wherein the controller maps an arbitrary physical address from among a plurality of physical addresses to each of the logical addresses, and generates the mapping table using a mapping relationship between the logical address and the physical address.

3. The storage device according to claim 1, wherein the controller generates the mapping table without receiving a write command from the outside of the storage device.

4. The storage device according to claim 1, wherein the controller sets all of the memory blocks, except the memory block set as an over-provision region from among the plurality of memory blocks, as fake blocks.

5. The storage device according to claim 1, wherein the controller sets some of the memory blocks, except the memory block set as an over-provision region from among the plurality of memory blocks, as fake blocks, and sets remaining memory blocks, except the memory blocks set as the fake blocks and memory blocks set as the over-provision region, as normal blocks.

6. The storage device according to claim 1, wherein, when receiving a read command for a fake block from the outside, the controller outputs information on the fake block stored in the mapping table.

7. The storage device according to claim 1, wherein, when receiving a write command for a fake block from the outside, the controller changes the physical address for the fake block to another physical address in the mapping table, and writes data according to the write command to the memory block corresponding to the changed physical address.

8. The storage device according to claim 1, wherein, when the number of free blocks among the plurality of memory blocks is less than a preset value, the controller performs a garbage collection operation, and the fake blocks are excluded from the free blocks.

9. The storage device according to claim 8, wherein, when performing the garbage collection operation, the controller selects the fake block as a source block among the plurality of memory blocks.

10. The storage device according to claim 9, wherein the controller writes a value obtained in a read operation on the source block, to a destination block to which data of the source block is to be moved.

11. The storage device according to claim 9, wherein the controller sets a destination block, to which the data of the source block is moved, as a fake block, and changes the source block to a normal block, in the fake block bitmap.

12. The storage device according to claim 9, wherein, when the garbage collection operation is completed, the controller changes the source block to a normal block in the fake block bitmap.

13. The storage device according to claim 5, wherein, when the number of free blocks from among the plurality of memory blocks is less than a preset value, the controller performs a garbage collection operation, and the fake blocks are excluded from the free blocks,
wherein, when performing the garbage collection operation, the controller selects, as a source block, a memory block written with data from among the normal blocks.

14. The storage device according to claim 1, further comprising:
a volatile memory configured to store the mapping table and the fake block bitmap.

15. The storage device according to claim 1, wherein at least two of the plurality of memory blocks configure a super block, and the fake block bitmap indicates whether the super block is a fake block.

16. The storage device according to claim 1, wherein the test mode is enabled according to a test mode start signal received from the outside.

17. A method for setting a test mode of a storage device, comprising:
mapping an arbitrary physical address to a logical address in a test mode;
generating a mapping table that maps the physical address and the logical address using a mapping relationship; and
setting a fake block bitmap indicating whether a memory block included in the mapping table is a fake block to which data is not written.

18. A controller comprising:
an interface configured to receive a test mode start signal from the outside; and
a control circuit configured to operate in a test mode according to the test mode start signal, generate a mapping table between physical addresses and logical addresses according to a plurality of memory blocks in the test mode, and set a fake block bitmap indicating whether the memory block included in the mapping table is a fake block to which data is not written.

19. The controller according to claim 18, further comprising:
a volatile memory configured to store the fake block bitmap.

20. The controller according to claim 18, wherein the fake block bitmap is stored in a memory located outside the controller.
